(19) United States
(12) Patent Application Publication
(10) Pub. No.: US 2006/0214856 A1
(43) Pub. Date: Sep. 28, 2006

(54) Broad band antenna

(75) Inventors: Hisamatsu Nakano, Tokyo (JP); Junji Yamauchi, Tokyo (JP); Yoichi Asano, Tokyo (JP); Daiichi Hashimoto, Tokyo (JP); Akira Usami, Tokyo (JP); Iwao Kiyofuji, Tokyo (JP); Makoto Sato, Tokyo (JP); Hidenori Shimizu, Tokyo (JP)

Correspondence Address: BACON & THOMAS, PLLC, 625 SLATERS LANE, FOURTH FLOOR, ALEXANDRIA, VA, 22314, US

(73) Assignee: SANSEI ELECTRIC Co., Ltd., Tokyo (JP)

(21) Appl. No.: 11/355,947

(22) Filed: Feb. 17, 2006

(30) Foreign Application Priority Data
Mar. 28, 2005 (JP) 2005-090843
Sep. 16, 2005 (JP) 2005-269521
Nov. 28, 2005 (JP) 2005-342471

(51) Int. Cl. H01Q 1/24; H01Q 1/38

(52) U.S. Cl. 343/702; 343/700 MS

(57) ABSTRACT

To provide a compact and light broad range antenna apparatus transmitting and receiving an electric wave in GHz frequency band (wavelength: λ), a flat shaped antenna element (10), where a length b′ in an X-axis direction is less than λ/4 and a length a′ in a Y-axis direction is less than λ/4, is arranged at a distance j less than λ/4 from a ground plate (2) in the Y-axis direction and connected to a high-frequency power source (9), and an enlarged flat shaped parasitic element (15) is structured by connecting a base portion (13) having approximately the same shape and dimension as those of the antenna element (10) with an extension portion (14) extending from the base portion (13) in the X-axis direction so as to face to the antenna element (10) with a distance, and connected conductively with the ground plate (2) by a ground line (5).

### FIELD OF THE INVENTION

The present invention relates to an antenna apparatus for transmitting and receiving an electric wave in GHz band, and more particularly to an antenna apparatus which is compact and is improved so as to obtain a broad band characteristic.

### PRIOR ART STATEMENT

### Description of Prior Art

A base of a technique for structuring an antenna resonating with the electric wave in the GHz band is to get a standing wave on a filament antenna.

In order to make the antenna compact, there has been widely known a technique of structuring the filament antenna mentioned above such as to resonate with a quarter of a wavelength λ. In this case, a mechanical length of the filament antenna comes to about λ/4.

In addition to the electric wave, a string, a rod and a gas basically resonate with integral multiples of λ/4, and does not resonate with a length less than λ/4 unless a particular structure is provided.

There has been known a technique of bending the filament antenna so as to form in a coil shape, or repeatedly folding the filament antenna so as to form in a meander shape, for making the antenna of λ/4 further shorter, however, the basic principle of resonating with λ/4 is fixed, and there does not exist a technical idea of making an electric length or a mechanical length of an antenna element less than λ/4. The prior arts appear, for example, in Japanese Unexamined Patent Publication No. 6-140820 (Patent Document 1), Japanese Unexamined Patent Publication No. 2004-7460 (Patent Document 2), Japanese Unexamined Patent Publication No. 2003-304114 (Patent Document 3) and ANTENNA ENGINEERING HANDBOOK edited by Institute of Electronics, Information and Communication Engineers, issued by Ohm Co. Ltd.) (Non-patent Document 1).

### Problem of Prior Art

In accordance with a development of a cellular phone and a wireless LAN (local area network) technique, an ultra wide band wireless system is planned.

It is requested to set a tuning characteristic of the antenna for transmitting and receiving the electric wave in the GHz band to be broad band and make the antenna compact and light.

### Object of the Invention

The present invention is made by taking the circumstance mentioned above into consideration, and an object of the present invention is to provide an antenna apparatus for GHz band having a broad band characteristic and being compact and light in comparison with the prior art.

### SUMMARY OF THE INVENTION

In order to achieve the object mentioned above, an antenna apparatus in accordance with the present invention is structured such that an antenna element having a length less than λ/4, with which turning has been impossible conventionally, can be used in the antenna apparatus.

First, for example, if a parasitic element having approximately identical diameter and dimensions is arranged near a cubic antenna element, an excellent antenna performance (VSWR value equal to or less than 2 and a wide frequency band) can be achieved even in case of a length of one side of the cubic being shortened to λ/8. The cube mentioned above can be modified, and a cuboid or a three-dimensional shape similar thereto may be employed.

Second, if a height of the cubic antenna element is shortened so as to be formed in a square plate shape, an excellent antenna performance can be achieved even in case of the length of one side of the square being shortened to λ/4. The square mentioned above can be modified, and a flat plate member of a rectangle or similar thereto may be employed.

Third, the wide frequency band mentioned above can be obtained under a condition that a parasitic element is provided together therewith. Accordingly, if an antenna apparatus assembly is structured by insert molding the antenna element and the parasitic element in one small resin block, the antenna apparatus assembly is easily used and has a high practical value.

### BRIEF DESCRIPTION OF THE DRAWINGS

FIG. 1 is a perspective view schematically describing an antenna apparatus in accordance with a first tentative proposal;

FIG. 2 is a view of a voltage standing wave ratio (VSWR) in the first tentative proposal;

FIG. 3 is a perspective view schematically showing an apparatus in accordance with a first aspect of the invention (claim 1);

FIG. 4 is a chart of the VSWR in the apparatus in accordance with the first aspect of the invention;

FIG. 5 is a perspective view showing a modified embodiment of the apparatus in accordance with the first aspect of the invention, and a second tentative proposal (claim 2);

FIG. 6 is a chart of the VSWR of the second tentative proposal shown in FIG. 5 mentioned above;

FIG. 7 is a schematic plan view for explaining the apparatus in accordance with a second aspect of the invention;

FIG. 8 is a plan view describing a detailed structure of the apparatus in accordance with the second aspect of the invention (claim 3) mentioned above;

FIG. 9 is a chart of the VSWR of the apparatus in accordance with the second aspect of the invention mentioned above;

FIG. 10 is a perspective view schematically showing an embodiment of an apparatus in accordance with a third aspect of the invention (claim 4); and

FIG. 11 is an exploded perspective view and an assembled perspective view showing a modified embodiment of the apparatus in accordance with the third aspect of the invention mentioned above.

### DETAILED DESCRIPTION OF THE PREFERRED EMBODIMENTS

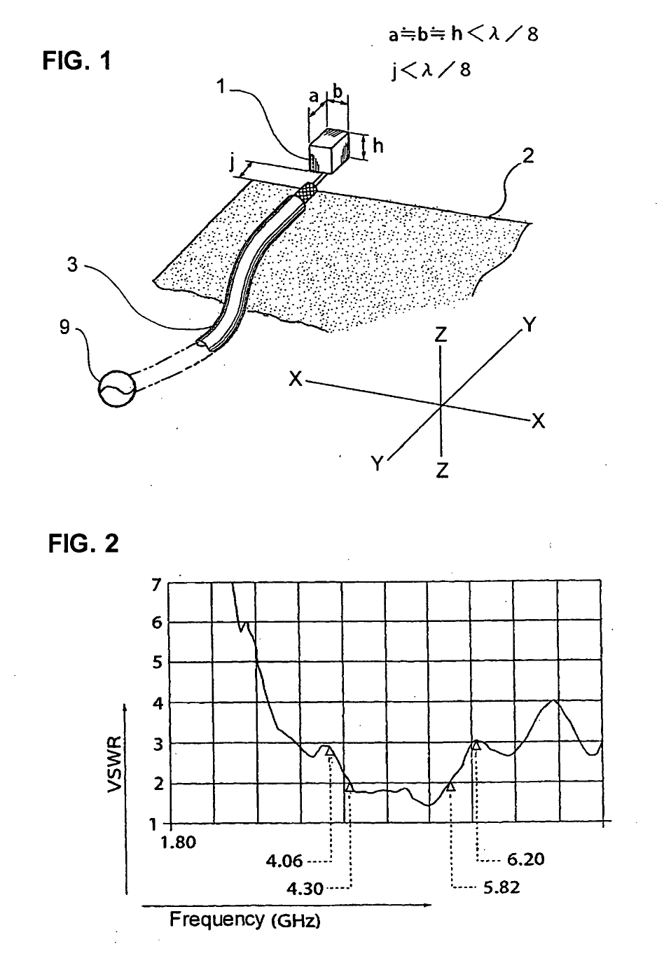

FIG. 1 is a perspective view schematically drawing a tentative proposal in the process of research for creating the present invention. In order to distinguish the other tentative proposal mentioned below, FIG. 1 is called as a first tentative proposal.

A wavelength of an electric wave to be transmitted and received is set to λ.

For sake of convenience for explanation, it is assumed that there are three orthogonal axes comprising a horizontal axis X which is parallel to an edge of a ground plate 2, an axis Y which is along a surface of the ground plate 2 and a vertical axis Z.

Reference numeral 1 denotes a cuboid shaped antenna element. In the cuboid shaped antenna element, a length a of one side in the Y-axis direction, a length b of one side in the X-axis direction and a length h in the Z-axis direction are approximately equal to each other, and are all less than λ/8. In other words, a relation of a≈b≈h<λ/8 is established, and the cuboid is close to a cubic shape.

Since a wavelength of the electric wave in the GHz band aimed by the present invention is about 10 cm, for example, in the case of 3 GHz, ⅛ thereof corresponds to about 1 cm, which is very small in comparison with the prior art.

The cuboid shaped antenna element 1 is arranged apart from the edge of the ground plate 2 at a distance j in the direction Y, and is connected to a high-frequency power source 9 by a coaxial cable 3. The distance j mentioned above is less than λ/8.

The VSWR of the antenna apparatus in accordance with the tentative proposal mentioned above is shown in FIG. 2. It is known that it has a comparatively wide frequency band in 4 to 6 GHz.

However, since it is necessary to transmit and receive the electric wave of 2.4 GHz in the case of being applied to, for example, a wireless LAN, it is desirable to enlarge the characteristic to a lower frequency side (a left side in the drawing) than that shown in FIG. 2.

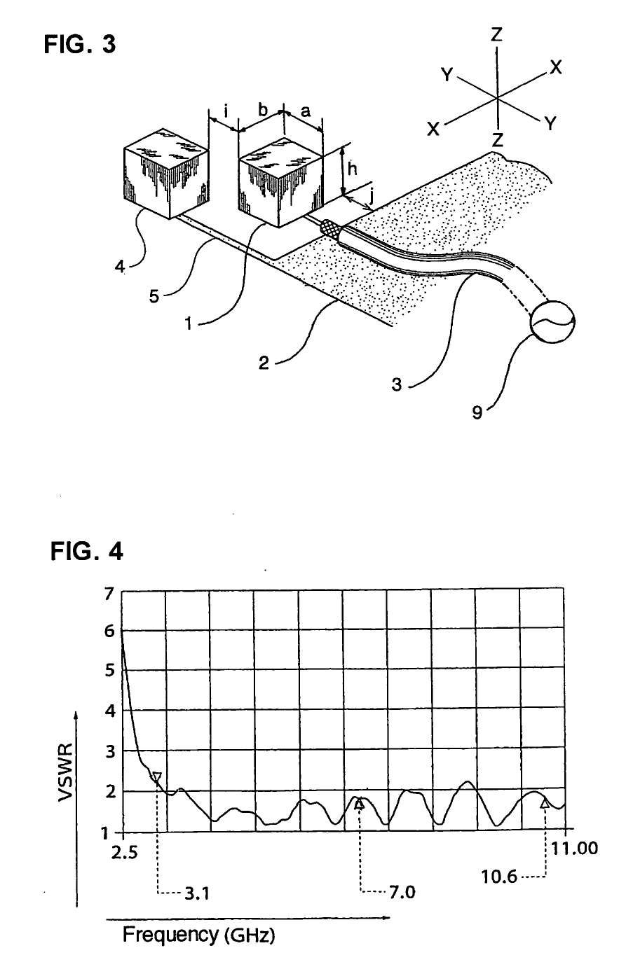

Then, the inventors of the present invention have created a first aspect of the invention shown in FIG. 3 by improving the antenna apparatus in accordance with the first tentative proposal shown in FIG. 1. In the present first aspect of the invention, a cuboid shaped parasitic element 4 is arranged in adjacent to the cuboid shaped antenna element 1 described above.

A shape and a dimension of the cuboid shaped parasitic element 4 is set similar to the cuboid shaped antenna element 1. The cuboid shaped parasitic element 4 is connected conductivlely to the ground plate 2 by a ground line 5.

A distance i between the cuboid shaped antenna element 1 and the cuboid shaped parasitic element 4 is less than λ/8.

The VSWR in the case of FIG. 3 (the first aspect of the invention) is shown in FIG. 4. Comparing this with the VSWR in FIG. 2 (the first tentative proposal) it is understood that “the frequency band of the tuning frequency is enlarged to the low frequency side by providing the cuboid shaped parasitic element 4”.

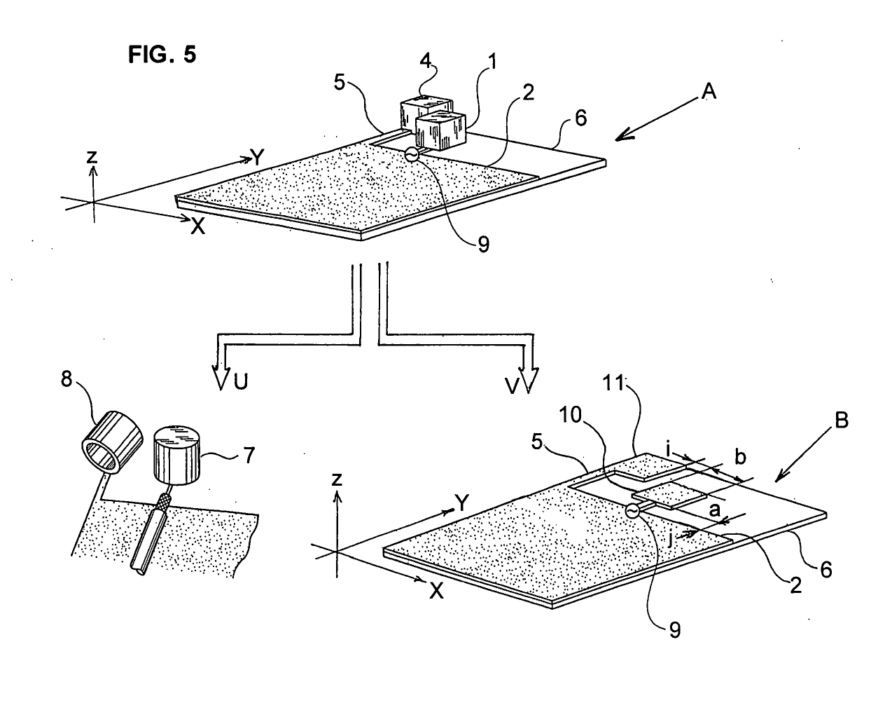

FIG. 5 is a view drawing a modified embodiment and an improved embodiment of the first aspect of the invention shown in FIG. 3, and a structure shown by attaching an arrow A corresponds to an embodiment of the antenna apparatus 1 in accordance with the first aspect of the invention. Even if the embodiment A in accordance with the first aspect of the invention is modified as shown by an arrow u, the same operation and effect can be obtained. In other words, even if the cuboid shaped antenna element 1 is modified to a columnar antenna element 7, the operation and the effect are the same as far as the magnitude is approximately identical.

Further, even if the cuboid shaped parasitic element 4 is modified to a cylindrical parasitic element 8, the operation and the effect are approximately the same as far as the outer shape is similar.

As is easily understood from the knowledge, the “cuboid” in the first aspect of the invention can be modified to “three-dimensional shape having approximately the same dimension”, and can be formed in a hollow shape, and both are included in the technical scope (claim) of the present invention.

The embodiment A in accordance with the first aspect of the invention comes close to a second aspect of the invention by being improved as shown by an arrow v (since the structure has not reached that of the second aspect of the invention yet, it is called as a second tentative proposal, and is shown by attaching an arrow B).

In this proposal, the cuboid shaped antenna element 1 comes to a flat shaped antenna element 10 by being modified to a flat shape by lowering a height of the cuboid shaped antenna element 1, and the cuboid shaped parasitic element 4 comes to a flat shaped parasitic element 11 by being modified to a flat shape by lowering a height of the cuboid shaped parasitic element 4.

A plan view of the second tentative proposal is similar to that of the first aspect of the invention (FIG. 3). Viewing this in a three-dimensional manner, this structure corresponds to a structure which is made extremely thin in a height direction.

In other words, the flat shaped antenna element 10 is apart from the edge of the ground plate 2 at a distance j less than λ/4 in the Y-axis direction, and the flat shaped antenna element 10 and the flat shaped parasitic element 11 are apart from each other at a distance i less than λ/4.

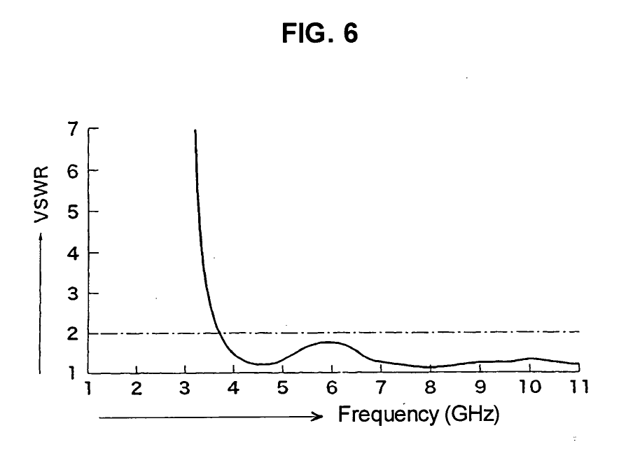

The VSWR of the antenna apparatus in accordance with the second tentative proposal mentioned above is as shown in FIG. 6.

A wide tuning characteristic is shown in GHz frequency band, however, tuning in a lower frequency side than 3 GHz is regrettably impossible. Then, the second tentative proposal is further improved as follows so as to enlarge the frequency band to the low frequency side.

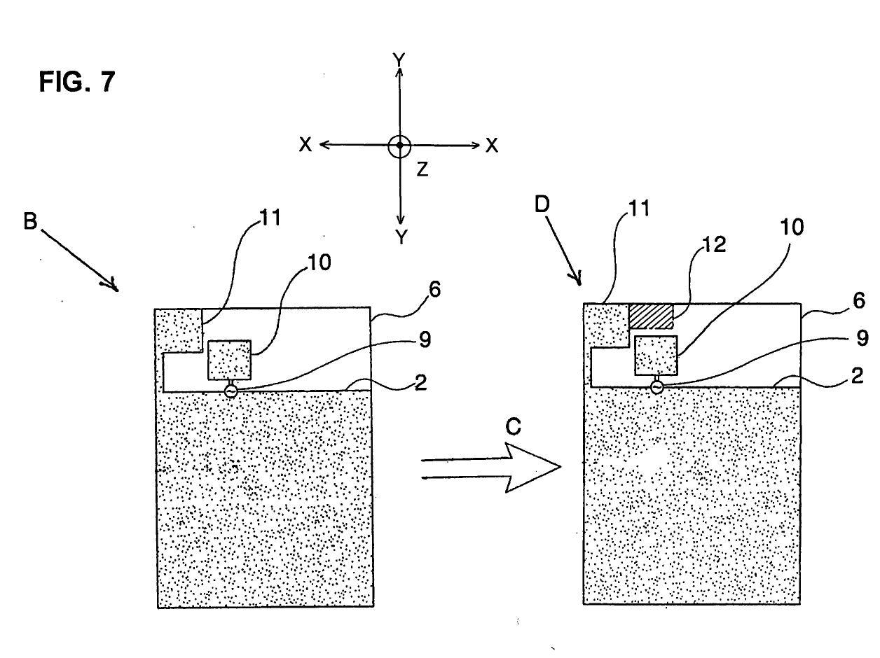

A view with an arrow B in FIG. 7 is a plan view of the antenna apparatus in accordance with the second tentative proposal shown by the arrow B in FIG. 5. In the second tentative proposal B, the flat shaped antenna element 10 and the flat shaped parasitic element 11 face to each other with a distance so as to be coupled in a manner of capacitance, however, the structure is improved as shown by an arrow C so as to make the coupling further dense.

In other words, a parasitic element extension portion 12 (shown by attaching a broken line) is provided so that a length of a line where the flat shaped parasitic element 11 faces to the flat shaped antenna element 10 with a distance, elongates.

In this case, although a length of one side of the cuboid shaped antenna element 1 mentioned above is λ/8, as a result of improving to the flat shaped element by lowering the height of the cuboid shaped element, it becomes hard to shorten the length of one side of the rectangle to λ/8, and it is proper to make the length of one side of the rectangle less than λ/4. However, since it is impossible to make the length less than λ/4 without bending or folding the antenna element in the prior art, a significance of “creating the antenna element having the length less than λ/4” by a structure shown by reference symbol D in FIG. 7 is great.

The structure (shown by an arrow D in FIG. 7) corresponds to the second aspect of the invention.

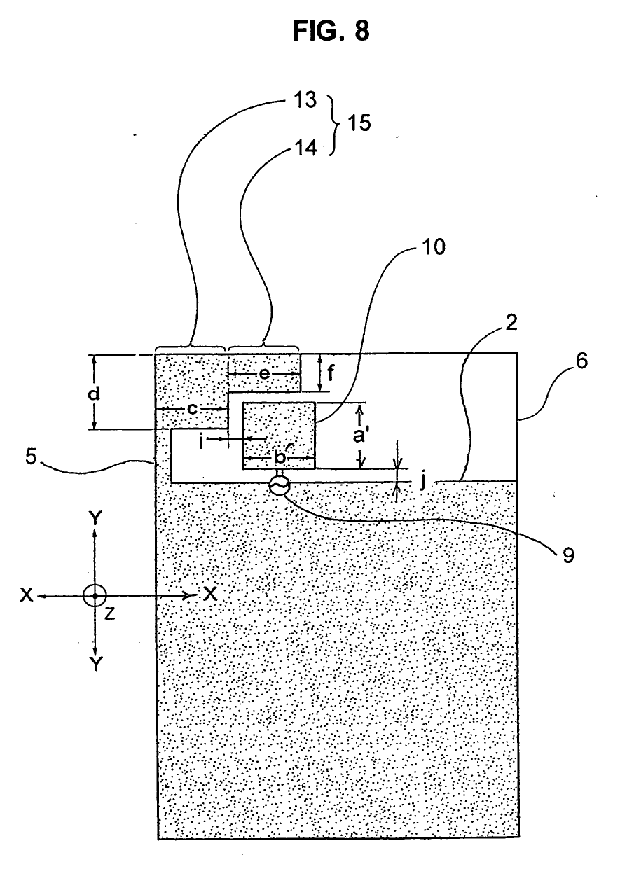

FIG. 8 is a detailed plan view of the antenna apparatus in accordance with the second aspect of the invention mentioned above. An element shown by attaching reference numeral 10 corresponds to the flat shaped antenna element similar to the second tentative proposal.

An enlarged flat shaped parasitic element 15 is structured by connecting an extension portion 14 similar to the parasitic element extension portion 12 described in FIG. 7 to a base portion 13 similar to the flat shaped parasitic element 11 in the second tentative proposal.

For sake of convenience for explanation, it is assumed that there are orthogonal coordinate axes X and Y as illustrated.

Reference symbol a′ denotes a length in a Y-axis direction of the flat shaped antennal element 10. The length is less than λ/4.

Reference symbol b′ denotes a length in an X-axis direction of the flat shaped antennal element 10. The length is less than λ/4.

Reference symbol c denotes a length in the X-axis direction of the base portion 13. The length is less than λ/4. Reference symbol d denotes a length in the Y-axis direction of the base portion 13. The length is less than λ/4. Reference symbol e denotes a length in the X-axis direction of the extension portion 14. The dimension thereof is described in detail later.

Reference symbol f denotes a length in the Y-axis direction of the extension portion 14. The length satisfies a relation of f<d.

Reference symbol i denotes a distance in the X-axis direction between the flat shaped antenna element 10 and the enlarged flat shaped parasitic element 15. The distance i is sufficiently smaller than the length e.

In the various dimensions mentioned above, the length e in the X-axis direction of the extension portion 14 greatly affects the antenna performance.

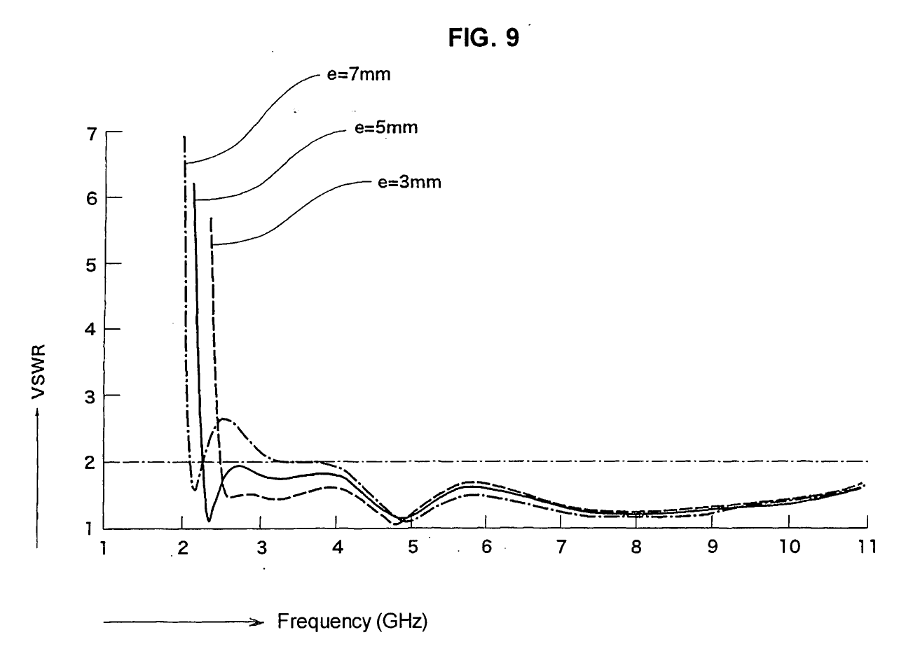

The VSWR obtained by changing the length e as a parameter to 3 mm, 5 mm and 7 mm is shown in FIG. 9.

It is understood that “the tuning frequency band is enlarged to the low frequency side in accordance with an increase of the length e”.

In the case of carrying out the present invention, it is preferable to appropriately set the length e in correspondence to a desired antenna performance.

In the first aspect of the invention mentioned above and the second aspect of the invention, the desired antenna performance can be obtained by arranging the antenna element and the parasitic element together.

The layout relation between the cuboid shaped antenna element 1 and the cuboid shaped parasitic element 4 is important in the first aspect of the invention (reference symbol A in FIG. 5), and the layout relation between the flat shaped antenna element 10 and the enlarged flat shaped parasitic element 15 is important in the second aspect of the invention (FIG. 8), respectively.

On the basis of the consideration mentioned above, it is desirable to seal the antenna element and the parasitic element together in the resin block. This corresponds to a third aspect of the invention.

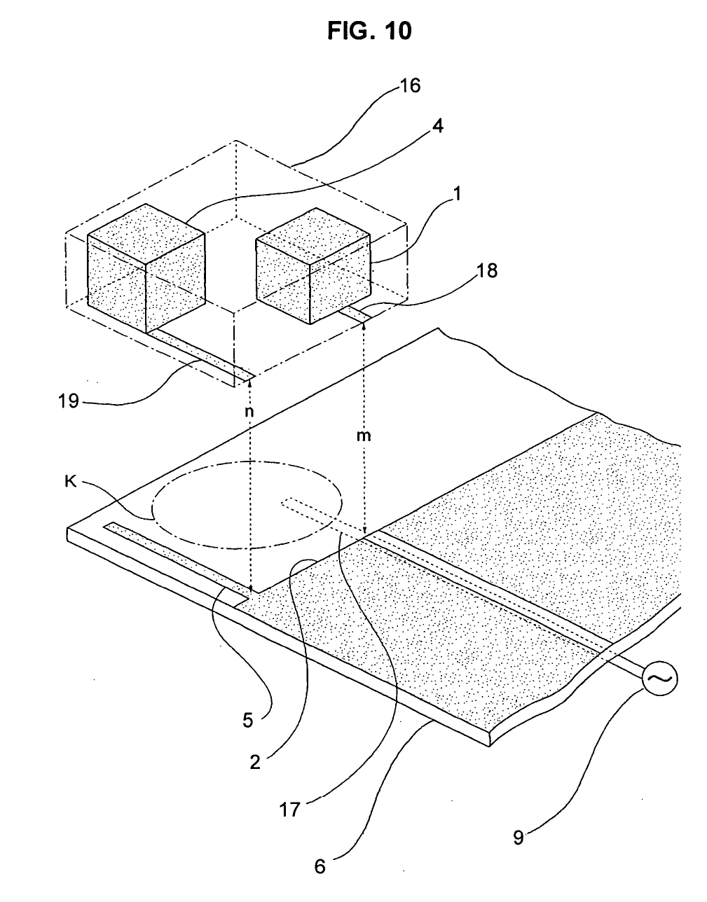

FIG. 10 shows a first embodiment in accordance with the third aspect of the invention.

The cuboid shaped antenna element 1 and the cuboid shaped parasitic element 4 are insert molded in the resin block 16. A feed line 18 is provided to the cuboid shaped antenna element 1, and a ground line 19 is provided to the cuboid shaped parasitic element 4.

On the other hand, the ground plate 2 is provided in a circuit board 6, and a space k for installing the resin block 16 is left in the circuit board 6.

A ground line 5 is integrally connected to the ground plate 2, and a micro strip line 17 is provided in the circuit board 6.

When the resin block 16 is installed in the space k of the circuit board 6, the feed line 18 is brought into contact with the micro strip line 17 as shown by an arrow m so as to be fed from the high-frequency power source 9, and the ground line 19 is brought into contact with the ground line 5 conductively as shown by an arrow n.

As a different embodiment from the embodiment mentioned above (FIG. 10), it is recommended to use a structure in which the flat shaped antenna element 10 and the enlarged flat shaped parasitic element 15 in the second aspect of the invention (FIG. 8) are sealed and fixed into the resin block, although an illustration is omitted.

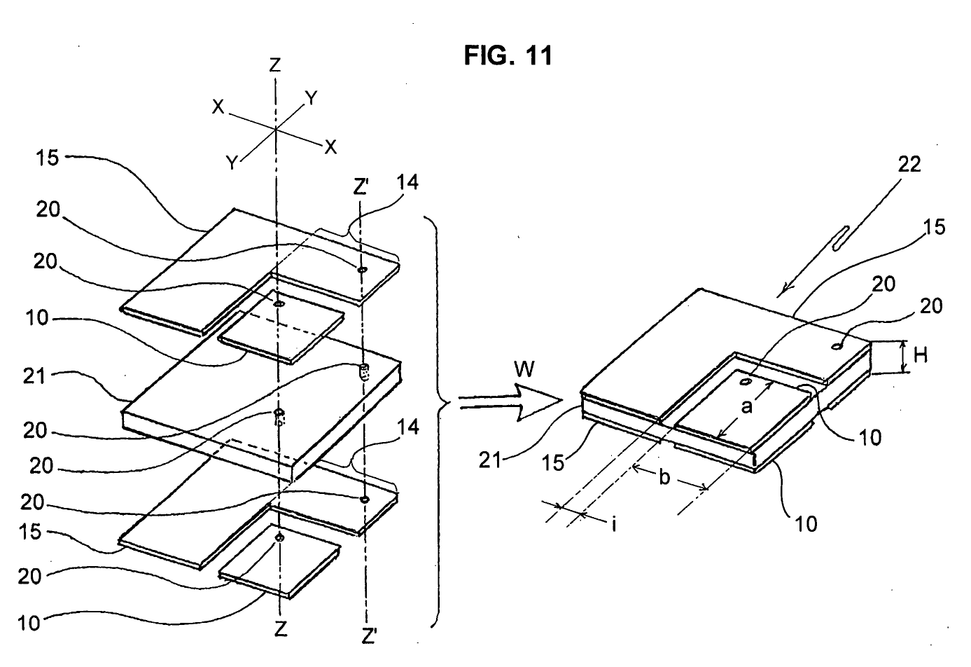

FIG. 11 shows a modified embodiment of the third aspect of the invention shown in FIG. 10 mentioned above. A left half of FIG. 11 is an exploded perspective view, and a right half of FIG. 11 is an assembled perspective view.

The flat shaped antenna elements 10 and the enlarged flat shaped parasitic elements 15 are arranged in upper and lower sides of a substrate chip 21 (refer to the left half portion). The elements are the similar members to those shown in FIG. 8 mentioned above.

It is assumed that there are an axis Z orthogonal to the axis X and the axis Y shown in FIG. 8, and an axis Z′ parallel to the axis Z, and through holes 20 are provided along the axis Z and the axis Z′. The through holes correspond to a means for connecting the both side elements conductively by applying a plating in the later step.

An antenna apparatus assembly 22 is formed by assembling as shown by an arrow w.

In the antenna apparatus assembly 22 mentioned above, the flat shaped antenna elements 10 and the enlarged flat shaped parasitic elements 15 are fixedly positioned with each other, it is possible to use it in place of the resin block 16 in FIG. 10.

In addition, since two flat shaped antenna elements 10 and two enlarged flat shaped parasitic elements 15 are arranged in the upper and lower sides so as to be conductive with each other, an improved antenna characteristic can be obtained.

What is claimed is:

1. An antenna apparatus for GHz frequency band, the antenna apparatus transmitting and receiving an electric wave having a wavelength λ, and three orthogonal axes, and including an axis parallel to an edge of a ground plate and an axis along a surface of the ground plate being set,
wherein a cuboid shaped antenna element, in which a length in a axis direction satisfies a relation a <λ/8, a length in an axis direction is less than λ/8 and a length in a axis direction is less than λ/8, is installed at a distance less than λ/8 from an edge of said ground plate in the axis direction, and
wherein a cuboid shaped parasitic element having approximately the same shape and the same dimension as those of said cuboid shaped antenna element is installed at a distance less than λ/8 from said cuboid shaped antenna element, said flat shaped antenna element is connected conductively with a high-frequency power source, and the flat shaped parasitic element is connected conductively with the ground plate, respectively.

2. The antenna apparatus for GHz frequency band, the antenna apparatus transmitting and receiving the electric wave having the wavelength λ, and wherein three orthogonal axes, and including the axis parallel to an edge of a ground plate and the axis along the surface of the ground plate being set,
wherein a flat shaped antenna element, in which the length in the axis direction is less than λ/4 and the length in the axis direction is less than λ/4, is installed at the distance less than λ/4 from an edge of said ground plate in the axis direction, and
wherein a flat shaped parasitic element having approximately the same shape and the same dimension as those of said flat shaped antenna element is installed at the distance less than λ/4 from said flat shaped antenna element, said flat shaped antenna element is connected conductively with the high-frequency power source, and the flat shaped parasitic element is connected conductively with the ground plate, respectively.

3. The antenna apparatus for GHz frequency band, the antenna apparatus transmitting and receiving the electric wave having the wavelength λ, and three orthogonal axes, and including the axis parallel to the edge of the ground plate and the axis along the surface of the ground plate being set,
wherein the flat shaped antenna element, in which the length in the axis direction is less than λ/4 and the length in the axis direction is less than λ/4, is installed at a distance less than λ/4 from the edge of said ground plate in the axis direction,
wherein the flat shaped parasitic element having approximately the same shape and the same dimension as those of said flat shaped antenna element is installed at the distance less than λ/4 from said flat shaped antenna element,
wherein a parasitic element extension portion is elongated in the axis direction from said flat-shaped parasitic element so as to form an enlarged flat shaped parasitic element facing to said flat shaped antenna element with a distance, and
wherein said flat shaped antenna element is connected conductively with the high-frequency power source, and the enlarged flat shaped parasitic element is connected conductively with the ground plate, respectively.

4. The antenna apparatus for GHz frequency band as claimed in claim 1, wherein the cuboid shaped antenna element and the cuboid shaped parasitic element are insert molded within one resin block, and a feed line and a ground line are respectively provided to said cuboid shaped antenna element and the cuboid shaped parasitic element.

5. The antenna apparatus for GHz frequency band, the antenna apparatus transmitting and receiving the electric wave having the wavelength λ, and three orthogonal axes, and being set,
wherein two flat shaped antenna elements, in which the length in the axis direction is less than λ/4 and the length in the axis direction is less than λ/4, are arranged so as to be brought into contact with surfaces in both sides of a substrate chip,
wherein two flat shaped parasitic elements having approximately the same shape and the same dimension as those of said flat shaped antenna elements are installed at the distance less than λ/4 from each of said two flat shaped antenna elements, and
wherein each of said two flat shaped antenna elements is elongated in the axis direction so as to be continuously provided with an extension portion facing to said flat shaped antenna element with a distance, thereby forming an enlarged flat shaped parasitic element.
